(19) United States
(12) Patent Application Publication
(10) Pub. No.: US 2007/0011372 A1
(43) Pub. Date: Jan. 11, 2007

(54) Signal adapter

(75) Inventor: Hank Wang, Hsin Chu (TW)

Correspondence Address: BACON & THOMAS, PLLC, 625 SLATERS LANE, FOURTH FLOOR, ALEXANDRIA, VA, 22314, US

(73) Assignee: 3 VIEW TECHNOLOGY CO., LTD, Hsin Chu (TW)

(21) Appl. No.: 11/447,101

(22) Filed: Jun. 6, 2006

(30) Foreign Application Priority Data
Jul. 5, 2005 (TW) 094211391

(51) Int. Cl. G06F 13/38

(52) U.S. Cl. 710/62

(57) ABSTRACT

A signal adapter for signally connecting a USB storage card and a USB port of an electronic apparatus is disclosed. The signal adapter comprises a casing, a slot for inserting the USB storage card therein, a bridge disposed in the casing and electrically coupled to the USB storage card for transmitting a USB format signal from the USB storage card, and a USB connector electrically coupled to the bridge and being inserted into the USB port of the electronic apparatus for transmitting the USB format signal to the electronic apparatus through the USB port.

### FIELD OF THE INVENTION

The present invention relates to a signal adapter, and more particularly to a signal adapter used for signally connecting a USB storage card and a USB port of an electronic apparatus.

### BACKGROUND OF THE INVENTION

The electronic cards, such as modem card, local area network card (LAN card), and memory card, are widely used nowadays, and tend to be smaller and smaller. The common memory cards include compact flash card (CF card), secure digital card (SD card), multimedia memory card (MMC card), mini secure digital card (MSD card) and RFMMC card, in which the CF card is gradually eliminated through competition due to its large size. In using these memory cards, a variety of corresponding card readers or signal adapters are required to connect the memory cards to a computer before data can be read from or written into the memory cards (US 2004/0145878).

With the progress of the electronic technology, many portable electronic apparatuses, such as digital camera, mobile phone and personal digital assistant (PDA), have functions of taking photographs and videos. Since the storage capacity of the portable electronic apparatus itself is limited, it needs an additional memory card for storing the files of the photographs and the videos. However, with the increase of the storage capacity of the memory card, the transmission speed of the conventional memory card cannot meet the requirement of the user, since it takes much time to download the files in the memory card to the computer. Therefore, another new memory card named USB storage card (USC) is provided recently. As shown in FIG. 1, each of the four sides of the USB storage card 10 has a set of contact pads 11, and each set of the contact pads 11 has five pins, which is one more than the conventional USB port, and the additional fifth pin can not only increase the transmission speed of the USB storage card, but also be provided for transmitting other signal.

Since the data stored in the USB storage card 10 needs to be downloaded through the USB port, it is needed to provide a signal adapter for signally connected the USB storage card and the USB port of the electronic apparatus.

### SUMMARY OF THE INVENTION

An object of the present invention is to provide a signal adapter for signally connecting a USB storage card and a USB port of an electronic apparatus.

According to an aspect of the present invention, there is provided a signal adapter for signally connecting a USB storage card and a USB port of an electronic apparatus. The signal adapter comprises a casing, a slot for inserting the USB storage card therein, a signal converter disposed in the casing and electrically coupled to the USB storage card for converting a signal transmitted from the USB storage card into a USB format signal, and a USB connector electrically coupled to the signal converter and being inserted into the USB port of the electronic apparatus for transmitting the USB format signal to the electronic apparatus through the USB port.

In an embodiment, the electronic apparatus is a desktop.

In an embodiment, the electronic apparatus is a portable electronic apparatus, such as a laptop or a personal digital assistant.

In an embodiment, the signal adapter further comprises a cover moving between two positions for protecting the USB connector when the USB connector is not inserted into the USB port of the electronic apparatus.

In an embodiment, the USB storage card has plural sets of contact pads, and each of the set of contact pads has five pins for electrically coupling to the signal converter.

In an embodiment, the casing is formed by assembling a plurality of plastic casings.

According to another aspect of the present invention, there is provided a signal adapter for being signally connected to a USB port of an electronic apparatus. The signal adapter comprises a USB storage card having plural sets of contact pads, a casing, a slot for inserting the USB storage card therein, a signal converter disposed in the casing and electrically coupled to the USB storage card for converting a signal transmitted from the USB storage card into a USB format signal, and a USB connector electrically coupled to the signal converter and being inserted into the USB port of the electronic apparatus for transmitting the USB format signal to the electronic apparatus through the USB port.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic diagram showing a USB storage card;

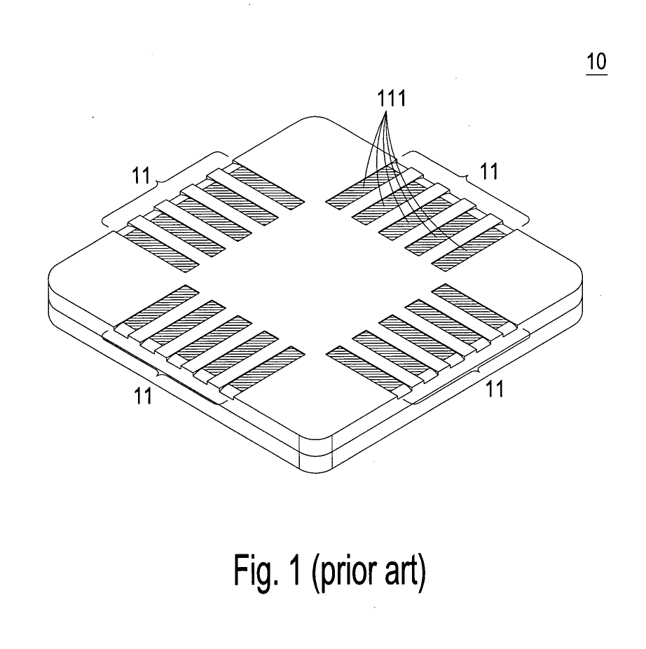

FIG. 2(a) is an exploded view showing the signal adapter according to the preferred embodiment of the present invention;

FIG. 2(b) is a front side view showing the assembled signal adapter of FIG. 2(a);

FIG. 2(c) is a back side view showing the assembled signal adapter of FIG. 2(a); and

FIG. 2(d) is a schematic diagram showing the USB storage card inserted in the signal adapter of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

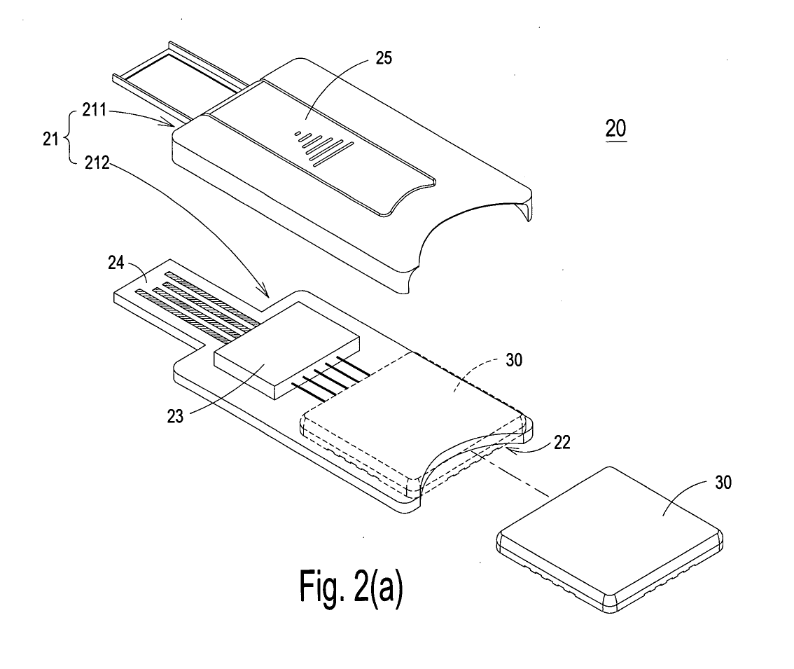

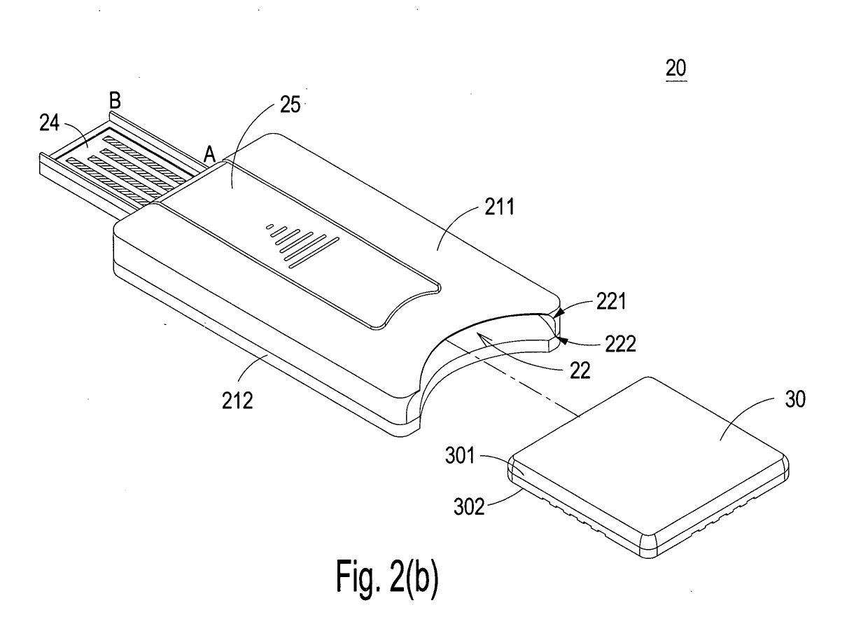

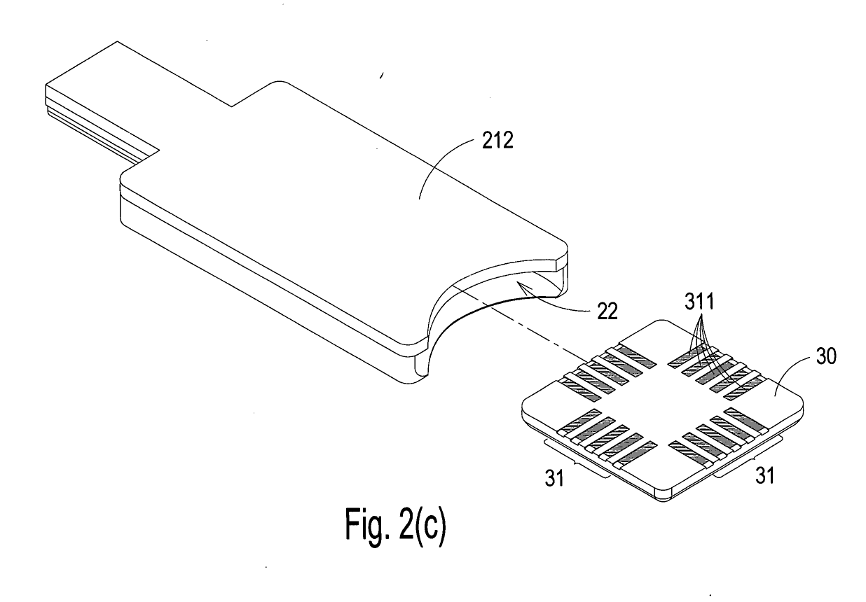

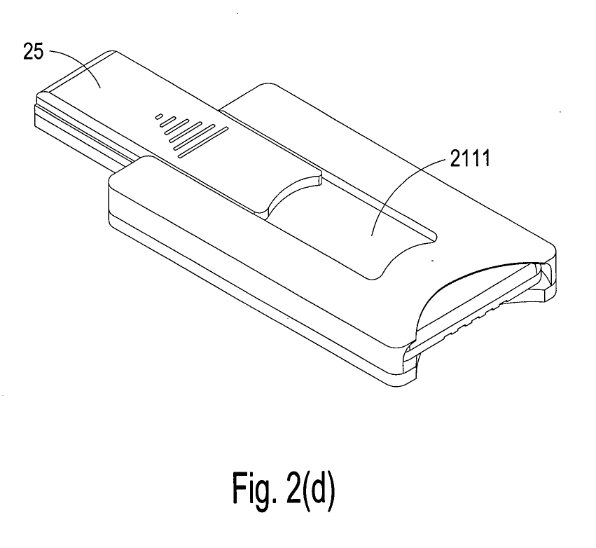

Please refer to FIG. 2(a), which is an exploded view showing the signal adapter according to the preferred embodiment of the present invention. As shown in FIG. 2(a), the signal adapter 20 is used for inserting a USB storage card (USC) 30 therein, so that the USB storage card 30 can be signally connected to a USB port of an electronic apparatus through the signal adapter 20. Therefore, the data stored in the USB storage card 30 can be downloaded to the storage media in the electronic apparatus, such as hard disks; alternatively, the data stored in the electronic apparatus can be stored to the USB storage card 30 through the signal adapter 20. The signal adapter 20 comprises a casing 21, a slot 22, a signal converter 23, a USB connector 24 and a cover 25. The casing 21 includes an upper plastic casing 211 and a lower plastic casing 212, which are assembled to be the box-like casing 21. Each of the four sides at the back of the USB storage card 30 has a set of contact pads 31 (as shown in FIG. 2(c)), and each set of the contact pads 31 are electrically coupled to the signal converter 23 for signal transmission. In addition, each set of the contact pads 31 has five pins 311, which is one more than the conventional USB port, and the additional fifth pin can not only increase the transmission speed of the USB storage card 30, but also be provided for transmitting other signal.

The USB storage card 30 is inserted into the space formed after the upper plastic casing 211 and the lower plastic casing 212 are assembled through the slot 22 (as shown in FIGS. 2(a) and 2(b)), and is electrically coupled to the signal converter 23 for signal transmission. The signal converter 23 is used for converting the signal transmitted from the USB storage card 30 into a USB format signal, or converting the signal transmitted from the electronic apparatus into a signal format that is readable to the USB storage card 30.

The other end of the signal converter 23 is electrically coupled to the USB connector 24. When the USB connector 24 is inserted into the USB port of the electronic apparatus, the USB format signal converted by the signal converter 23 can be transmitted to the interior of the electronic apparatus for storage through the USB connector 24 and the USB port; alternatively, the signal of the electronic apparatus can be transmitted to the signal converter 23 through the USB port and the USB connector 24 for signal conversion and then being stored in the USB storage card 30.

Please refer to FIGS. 2(b) and 2(d). The signal adapter 20 comprises a cover 25, which is received in the groove 2111 on the upper plastic casing 211, and can be slid and moved between positions A and B. When the USB connector 24 is inserted into the USB port of the electronic apparatus, the cover 25 is completely received in the groove 2111. On the other hand, when the signal adapter 20 is not in use, the cover 25 can be moved to position B from position A, so as to cover the USB connector 24 (as shown in FIG. 2(d)) for preventing dust or other foreign matter from falling into the USB connector 24 and protecting the USB connector 24.

In the preferred embodiment, as shown in FIG. 2(b), the two upper corners 221 of the slot 22 are arc-shaped while the two lower corners 222 of the slot 22 are rectangular. Correspondingly, the two upper laterals 301 of the USB storage card 30 are also arc-shaped and the two lower laterals 302 are rectangular. Therefore, the USB storage card 30 will not be inversely inserted into the slot 22. Of course, the corresponding structures on the slot 22 and the USB storage card 30 can be designed as any other structures only if the purpose for preventing inverse insertion can be achieved.

Certainly, the electronic apparatus can be a desktop or a portable electronic apparatus, such as laptop or personal digital assistant (PDA), but not limited thereto; any other electronic apparatus that has the USB port can be included within the scope of the present invention.

In conclusion, via the signal adapter of the present invention, the USB storage card and the USB port of the electronic apparatus can be signally connected, so that the data stored in the USB storage card can be downloaded to the electronic apparatus, and vice versa. Therefore, the signal adapter of the present invention possesses industrial value.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A signal adapter for signally connecting a USB storage card and a USB port of an electronic apparatus, said signal adapter comprising:
a casing;
a slot for inserting said USB storage card therein;
a bridge disposed in said casing and electrically coupled to said USB storage card for transmitting a USB format signal from said USB storage card; and
a USB connector electrically coupled to said bridge and being inserted into said USB port of said electronic apparatus for transmitting said USB format signal to the electronic apparatus through said USB port.

2. The signal adapter according to claim 1 wherein said electronic apparatus is a desktop.

3. The signal adapter according to claim 1 wherein said electronic apparatus is a portable electronic apparatus.

4. The signal adapter according to claim 3 wherein said portable electronic apparatus is a laptop or a personal digital assistant.

5. The signal adapter according to claim 1 further comprising a cover moving between two positions for protecting said USB connector when said USB connector is not inserted into said USB port of said electronic apparatus.

6. The signal adapter according to claim 1 wherein said USB storage card has plural sets of contact pads, and each of said set of contact pads has plural pins for electrically coupling to said bridge.

7. The signal adapter according to claim 1 wherein said casing is formed by assembling a plurality of plastic casings.

8. The signal adapter according to claim 1 wherein two upper corners of said slot are arc-shaped and two lower corners of said slot are rectangular.

9. The signal adapter according to claim 8 wherein two upper laterals of said USB storage card are arc-shaped and two lower laterals are rectangular.

10. A signal adapter for being signally connected to a USB port of an electronic apparatus, said signal adapter comprising:
a USB storage card having plural sets of contact pads;
a casing;
a slot for inserting said USB storage card therein;
a bridge disposed in said casing and electrically coupled to said USB storage card for transmitting a USB format signal from said USB storage; card; and
a USB connector electrically coupled to said bridge and being inserted into said USB port of said electronic apparatus for transmitting said USB format signal to the electronic apparatus through said USB port.

11. The signal adapter according to claim 10 wherein said electronic apparatus is a desktop.

12. The signal adapter according to claim 10 wherein said electronic apparatus is a portable electronic apparatus.

13. The signal adapter according to claim 12 wherein said portable electronic apparatus is a laptop or a personal digital assistant.

14. The signal adapter according to claim 10 further comprising a cover moving between two positions for protecting said USB connector when said USB connector is not inserted into said USB port of said electronic apparatus.

15. The signal adapter according to claim 10 wherein each of said set of contact pads has plural pins for electrically coupling to said bridge.

16. The signal adapter according to claim 10 wherein two upper corners of said slot are arc-shaped and two lower corners of said slot are rectangular.

17. The signal adapter according to claim 16 wherein two upper laterals of said USB storage card are arc-shaped and two lower laterals are rectangular.
